(19) United States
(12) Patent Application Publication
(10) Pub. No.: US 2026/0342248 A1
(43) Pub. Date: Oct. 29, 2026

(54) MOTOR CONTROL DEVICE AND IMAGE FORMING APPARATUS

(71) Applicant: CANON KABUSHIKI KAISHA, Tokyo (JP)

(72) Inventors: MASAYA MORITA, Ibaraki (JP); SHUHEI HAMADA, Chiba (JP)

(21) Appl. No.: 19/654,221

(22) Filed: Apr. 21, 2026

(30) Foreign Application Priority Data
Apr. 23, 2025 (JP) 2025-071227

(51) Int. Cl. H02P 5/747; G03G 15/00

(52) U.S. Cl. CPC H02P 5/747; G03G 15/5008; G03G 15/55; G03G 15/757; G03G 15/80

(57) ABSTRACT

A motor control device controls a driving current of a first motor based on a driving current supplied to the first motor detected by a current detection unit and a rotational position of the first motor detected by a first rotational position detection unit, and controls a driving current of a second motor based on the driving current supplied to the first motor detected by the current detection unit and a rotational position of the second motor detected by a second rotational position detection unit.

### BACKGROUND

### Field of the Technology

The present disclosure relates to a motor control device in an image forming apparatus such as a copying machine, a printer, a facsimile, or a multifunction peripheral having a plurality of functions thereof, and an image forming apparatus equipped with the motor control device.

### Description of the Related Art

In recent years, an image forming apparatus has been required to improve printing speed and extend a service life of a service part, and accordingly, high output of a motor used in the image forming apparatus has been required.

In order to cope with the high output of a motor, Japanese Patent Application Laid-Open No. 2021-22979 proposes a method of driving a load that is a driving target by using a plurality of small motors. As described therein, by using a plurality of inexpensive small motors, it is possible to obtain high output with an inexpensive configuration without using a large and high-output expensive motor.

FIG. 7 and FIG. 8 are an explanatory diagram illustrating a conventional configuration in which one rotating member is controlled with high accuracy by a plurality of motors as disclosed in Japanese Patent Application Laid-Open No. 2021-22979.

In FIG. 7 and FIG. 8, a first motor 4021 and a second motor 4031 are connected to a speed reducer 4041, and the speed reducer 4041 is connected to a rotating member 4091 that is a load. With this configuration, the rotating member 4091 can be rotated by the two motors 4021 and 4031.

In this configuration, the first motor 4021 and the second motor 4031 are provided with a first rotational position sensor 4051c and a second rotational position sensor 4051d which are sensors for detecting respective rotational positions.

In addition, a current detection circuit 4071c and a current detection circuit 4071d are provided to detect currents flowing through the first motor 4021 and the second motor 4031, respectively.

A current control circuit 4013a and a current control circuit 4013b respectively perform current control of the first motor 4021 and the second motor 4031 by using the rotational position information from the first rotational position sensor 4051c and the second rotational position sensor 4051d and the current information from the current detection circuit 4071c and the current detection circuit 4071d, so that a voltage can be applied at a timing at which the motors can efficiently rotate, and the responsiveness of the motors can be improved.

However, providing the current control circuit and the current detection circuit in each motor as described above leads to an increase in the cost of the entire device.

### SUMMARY

The present disclosure has been made in view of the above circumstances, and an object of the present disclosure is to provide a motor control device capable of obtaining, even if a current control circuit and a current detection circuit are not provided for each of a plurality of motors, motor driving performance equivalent to that of a configuration in which the circuits are provided for each of the plurality of motors in a configuration in which a load that is a driving target is driven by the plurality of motors, and achieving cost reduction, and an image forming apparatus equipped with the motor control device.

In order to achieve the above object, the present disclosure relates to a motor control device and an image forming apparatus equipped with the motor control device, the motor control device including a first motor, a second motor, a driving force transmission unit that is connected to the first motor and the second motor and combines a driving force of the first motor and a driving force of the second motor and outputs a combined driving force, a current control portion that controls driving currents of the first motor and the second motor in common, a current detection unit that detects a driving current supplied to the first motor and feeds back the driving current to the current control portion, a first rotational position detection unit that detects a rotational position of the first motor, and a second rotational position detection unit that detects a rotational position of the second motor, in which, the current control portion controls a driving current of the first motor based on a driving current supplied to the first motor detected by the current detection unit and a rotational position of the first motor detected by the first rotational position detection unit, and controls a driving current of the second motor based on the driving current supplied to the first motor detected by the current detection unit and a rotational position of the second motor detected by the second rotational position detection unit.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic front cross-sectional view of an image forming apparatus according to an embodiment of the present disclosure.

FIG. 2 is a circuit block diagram illustrating a control circuit configuration of the image forming apparatus according to the embodiment of the present disclosure.

FIG. 3 is a block diagram of a motor control device according to the embodiment of the present disclosure.

FIG. 4 is a block diagram of a control target of the motor control device according to the embodiment of the present disclosure.

FIG. 5 is a comparative diagram of output waveforms according to the embodiment of the present disclosure.

FIG. 6 is a flowchart illustrating control of the motor control device in a CPU according to the embodiment of the present disclosure.

FIG. 7 is an explanatory diagram of a conventional configuration.

FIG. 8 is an explanatory diagram of a conventional configuration.

### DESCRIPTION OF THE EMBODIMENTS

Hereinafter, exemplary embodiments of the present disclosure will be described in detail with reference to the drawings. Note that the constituents described in the following embodiments are merely examples, and various conditions such as a configuration, a function, a dimension, a material, a shape, a relative arrangement, and the like of an apparatus to which the present disclosure is applied can be modified or changed as appropriate without departing from the concept of the present disclosure, and are not limited to the following embodiments.

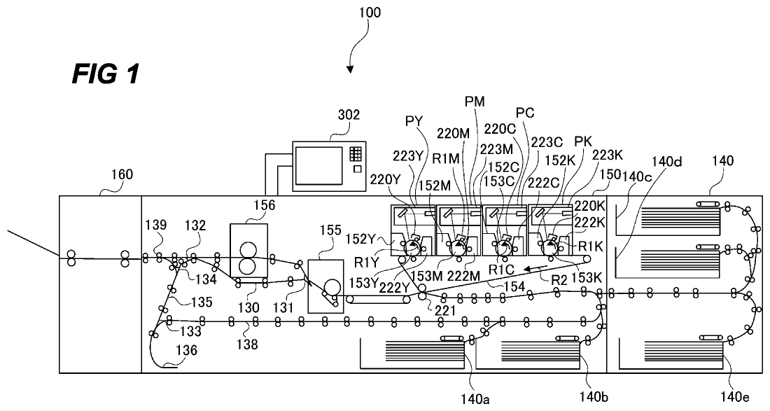

FIG. 1 is a schematic front cross-sectional view of an image forming apparatus according to an embodiment of the present disclosure.

In FIG. 1, the image forming apparatus 100 includes a sheet feeder 140, a printer 150, and a finisher 160.

The sheet feeder 140 is a device that feeds recording sheets as stacked recording materials to the printer 150. The recording sheets are stacked on sheet feed trays 140a, 140b, 140c, 140d, and 140e. The stacked recording sheets are fed and conveyed by motors that will be described later rotating various rollers, and are sent to the printer 150. The paper feed trays 140a and 140b are built in the printer 150.

The printer 150 serving as an image forming portion includes four image forming units PY, PM, PC, and PK. The four image forming units PY, PM, PC, and PK include an image forming unit PY that forms a yellow (Y) image, an image forming unit PM that forms a magenta (M) image, an image forming unit PC that forms a cyan (C) image, and an image forming unit PK that forms a black (K) image. Since the configurations of the image forming units PY, PM, PC, and PK are substantially the same except that the developing colors are different, the yellow image forming unit PY will be described in detail below, and for description of the other image forming units PM, PC, and PK, the same reference numerals and the reference signs M, C, and K are assigned to the corresponding configurations, and description thereof will be omitted.

The image forming unit PY includes a photosensitive drum 153Y, a charger 220Y, an exposure device 223Y, a development device 152Y, and a cleaner 222Y. The photosensitive drum 153 is rotated in a direction of an arrow R1Y by a motor that will be described later. The charger 220Y charges the surface of the photosensitive drum 153Y. The exposure device 223Y exposes the photosensitive drum 153Y. As a result, an electrostatic latent image is formed on the photosensitive drum 153Y. The development device 152Y develops the electrostatic latent image by using a developer (toner). As a result, the electrostatic latent image on the photosensitive drum 153Y is visualized, and a toner image is formed on the photosensitive drum 153Y. Then, the toner image formed on the photosensitive drum 153Y is transferred to an intermediate transfer belt 154. The toner remaining on the photosensitive drum 153Y after being transferred to the intermediate transfer belt 154 is removed by the cleaner 222Y.

Images of yellow, magenta, cyan, and black formed by the image forming units PY, PM, PC, and PK are transferred to the intermediate transfer belt 154 to overlap each other. As a result, a full-color image is formed on the intermediate transfer belt 154. The image on the intermediate transfer belt 154 is conveyed in a direction of an arrow R2. The image formed on the intermediate transfer belt 154 is transferred to a recording sheet conveyed from the sheet feeder 140 at a nip portion between the intermediate transfer belt 154 and a transfer roller 221. The intermediate transfer belt 154 is conveyed in the direction of the arrow R2 by a motor that will be described later rotating a driving roller.

The printer 150 includes a first fixing device 155 and a second fixing device 156 that heat and pressurize an image transferred onto a recording sheet to fix the image to the recording sheet. The first fixing device 155 includes a fixing roller having a heater therein, and a pressure belt for pressing the recording sheet against the fixing roller. The fixing roller is driven by a motor that will be described later to convey the recording sheet. The second fixing device 156 is disposed further toward the downstream side than the first fixing device in the conveyance direction of the recording sheet. The second fixing device 156 increases the gloss with respect to the image on the recording sheet that has passed through the first fixing device 155, and secures the fixability. The second fixing device 156 includes a fixing roller having a heater therein and a pressure roller having a heater therein. There may not be a need to use the second fixing device 156 depending on the type of recording sheet. In this case, the recording sheet is conveyed to the conveyance path 130 without passing through the second fixing device 156. A flapper 131 switches between guiding the recording sheet to a conveyance path 130 and guiding the recording sheet to the second fixing device 156.

A flapper 132 switches between guiding the recording sheet to a conveyance path 135 and guiding the recording sheet to a discharge path 139. In the duplex printing mode, the flapper 132 guides the recording sheet of which the image is formed on the first surface to the conveyance path 135. In addition, the flapper 132 guides the recording sheet of which the image is formed on the first surface to the discharge path 139 in the face-up sheet discharge mode. The flapper 132 guides the recording sheet of which the image is formed on the first surface to the conveyance path 135 in the face-down sheet discharge mode. After an adjustment chart is printed on the first surface of the recording sheet, the flapper 132 guides the recording sheet to the conveyance path 135 in order to print the adjustment chart on the second surface of the recording sheet.

The recording sheet conveyed to the conveyance path 135 is conveyed to a reversing portion 136. The recording sheet conveyed to the reversing portion 136 is switched back to reverse the conveyance direction of the recording sheet after the conveyance operation is temporarily stopped. Next, the flapper 133 switches between guiding the recording sheet to the conveyance path 138 or guiding the recording sheet to the conveyance path 135. The flapper 133 guides the switched-back recording sheet to the conveyance path 138 in the duplex printing mode. The flapper 133 guides the switched-back recording sheet to the conveyance path 135 in the face-down sheet discharge mode. Further, the recording sheet conveyed to the conveyance path 135 by the flapper 133 is guided to the discharge path 139 by the flapper 134. The flapper 133 guides the switched-back recording sheet to the conveyance path 138 in order to print the adjustment chart on the second surface of the recording sheet.

The recording sheet conveyed to the conveyance path 138 by the flapper 133 is conveyed toward the nip portion between the intermediate transfer belt 154 and the transfer roller 221. As a result, the front and back sides of the recording sheet when passing through the nip portion are reversed.

The recording sheet is conveyed in the printer 150 by a motor that will be described later rotating a driving roller.

The finisher 160 is a post-processing device that performs post-processing on a recording sheet from the printer 150. The finisher 160 performs, for example, a stapling process and a sorting process on a plurality of recording sheets.

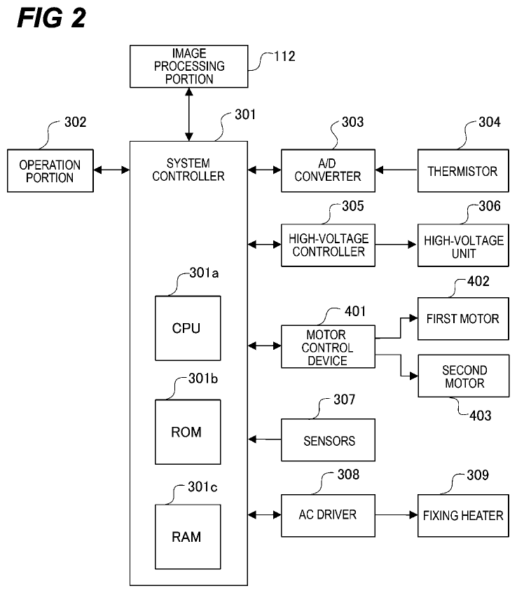

FIG. 2 is a circuit block diagram illustrating a control circuit configuration of the image forming apparatus 100.

In FIG. 2, a system controller 301 includes a CPU 301a, a ROM 301b, and a RAM 301c. In addition, the system controller 301 is connected to an image processing portion 112, an operation portion 302, an analog/digital (A/D) converter 303, a high-voltage controller 305, a motor control device 401, sensors 307, and an AC driver 308. The system controller 301 can transmit and receive data and commands to and from the connected units.

The CPU 301a reads and executes various programs stored in the ROM 301b to execute various sequences related to a predetermined image forming sequence. The RAM 301c is a storage device. The RAM 301c stores, for example, various data such as a setting value for the high-voltage controller 305, a command value for the motor control device 401, and information received from the operation portion 302.

The system controller 301 transmits setting value data of various devices provided inside the printer 150, which is necessary for image processing in the image processing portion 112, to the image processing portion 112. The system controller 301 further receives a signal from sensors 307 and sets a setting value of the high-voltage controller 305 based on the received signal. The high-voltage controller 305 supplies a necessary voltage to the high-voltage unit 306 (e.g., the charger 220, the development device 152, and the like) according to the setting value set by the system controller 301. Note that the sensors 307 include a sensor or the like that detects the recording sheet conveyed by the conveying roller.

The motor control device 401 controls a first motor 402 as a first motor that drives a load and a second motor 403 as a second motor according to a command output from the CPU 301a. Although only one motor control device 401 is illustrated in FIG. 2, a plurality of motor control devices is actually provided in the image forming apparatus 100.

The A/D converter 303 receives a detection signal detected by a thermistor 304 that detects the temperature of a fixing heater 309, converts the detection signal from an analog signal to a digital signal, and transmits the digital signal to the system controller 301. The system controller 301 controls the AC driver 308 based on the digital signal received from the A/D converter 303. The AC driver 308 controls the fixing heater 309 so that the temperature of the fixing heater 309 becomes a temperature necessary for performing the fixing process. Note that the fixing heater 309 is a heater used for the fixing process and is provided in the first fixing device 155 and the second fixing device 156.

The system controller 301 controls the operation portion 302 so that an operation screen for a user to set the type of the recording sheet to be used or the like (hereinafter, referred to as a sheet type) is displayed on a display portion provided in the operation portion 302. The system controller 301 receives the information set by the user from the operation portion 302, and controls the operation sequence of the image forming apparatus 100 based on the information set by the user. In addition, the system controller 301 transmits information indicating a state of the image forming apparatus 100 to the operation portion 302. Note that the information indicating the state of the image forming apparatus 100 is, for example, information regarding the number of sheets for image formation, a progress status of an image forming operation, and jam or double feed of recording sheets. The operation portion 302 displays the information received from the system controller 301 on the display portion.

As described above, the system controller 301 controls the operation sequence of the image forming apparatus 100.

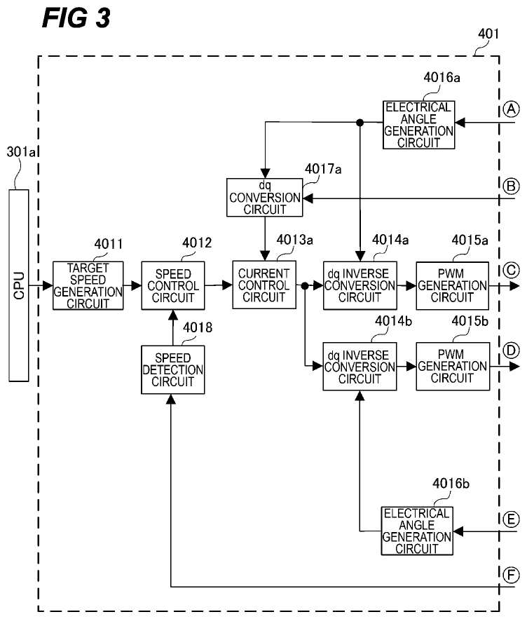

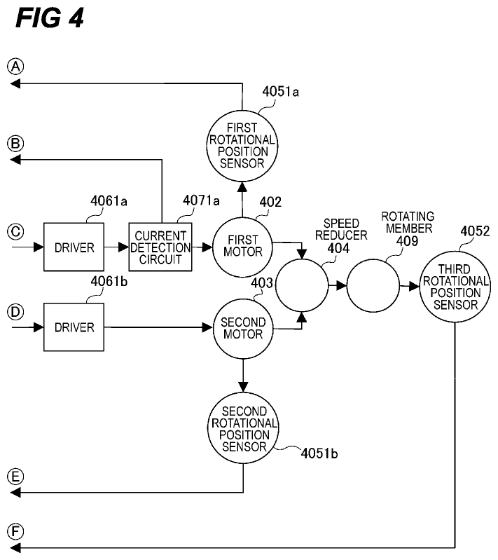

Next, the motor control device 401 will be described with reference to FIG. 3 and FIG. 4. FIG. 3 is a block diagram of the motor control device 401. FIG. 4 is a block diagram of a control target of the motor control device 401.

In FIG. 3, the CPU 301a controls the motor control device 401 by outputting a control signal related to motor control to the motor control device 401. In this control signal, 0 is a signal for giving an instruction for non-control, and 1 is a signal for giving an instruction for rotation control of the first motor 402 and the second motor 403.

The motor control device 401 includes a speed control circuit 4012, a current control circuit 4013a, and a PWM generation circuit 4015. By acquiring rotational positions of the first motor 402, the second motor 403, and the rotating member 409 and current information of the first motor 402, PWM voltage commands for the first motor 402 and the second motor 403 are generated. Details of generating the PWM voltage commands in the motor control device 401 will be described later.

The driver 4061a and the driver 4061b receive a PWM voltage command generated from the PWM generation circuit 4015 serving as a PWM generation unit in the motor control device 401, and apply a PWM voltage to the first motor 402 and the second motor 403.

The current detection circuit 4071a serving as a current detection unit detects three-phase currents flowing through the first motor 402. The detected current value is fed back to the current control circuit 4013a in the motor control device 401 and used. The current detection circuit 4071a is generally provided with a current detection resistor, and detects a current value by detecting a voltage across both ends of the current detection resistor with an AD converter.

The first motor 402 and the second motor 403 each output torque by being rotated by using the input PWM voltage. In the present embodiment, a three-phase DC brushless motor will be described as an example, but the present disclosure is not limited to the DC brushless motor.

In order to simplify the description, the description will be made assuming that the number of gear teeth of the first motor 402 is the same as the number of gear teeth of the second motor 403, but the number of gear teeth of the first motor 402 may be different from the number of gear teeth of the second motor 403.

The first rotational position sensor 4051a serving as a first rotational position detection unit detects a rotational position of the first motor 402. A rotary encoder or the like is used to detect the rotational position. The rotary encoder includes a light emitting portion that emits light, a light receiving portion that receives the light emitted from the light emitting portion, and a disk in which a slit through which the light emitted from the light emitting portion passes is provided at each predetermined rotational position, and outputs a pulse signal as a detection result each time the light receiving portion receives the light.

The second rotational position sensor 4051b serving as a second rotational position detection unit detects a rotational position of the second motor 403. A rotary encoder or the like is used to detect the rotational position.

The third rotational position sensor 4052 serving as a position information detection unit detects a rotational position which is operation position information of the rotating member 409. A rotary encoder or the like is used to detect the rotational position.

The speed reducer 404 serving as a driving force transmission unit combines torque (e.g., driving forces) corresponding to outputs from the first motor 402 and the second motor 403, and transmits the combined torque to the rotating member 409 that is a driving target serving as a load at a desired rotational speed.

The rotating member 409 rotates at the torque transmitted by the speed reducer 404. The rotating member 409 corresponds to the photosensitive drum 153, the fixing roller, the driving roller of the intermediate transfer belt, the conveyance driving roller of the recording sheet, or the like in the image forming apparatus 100.

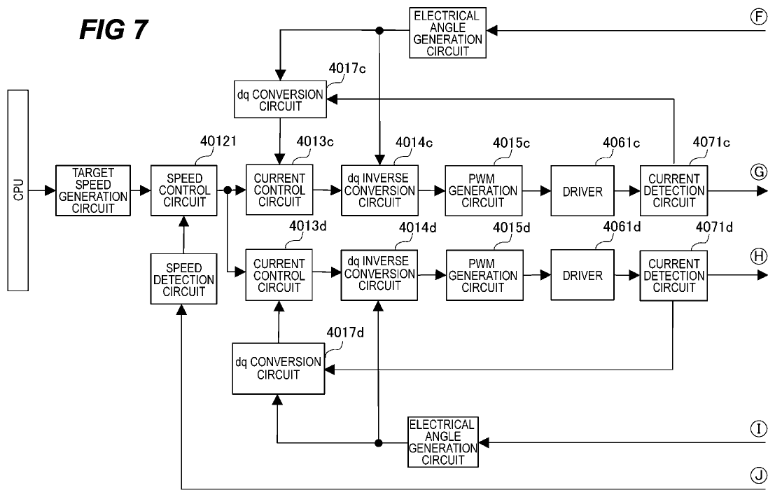

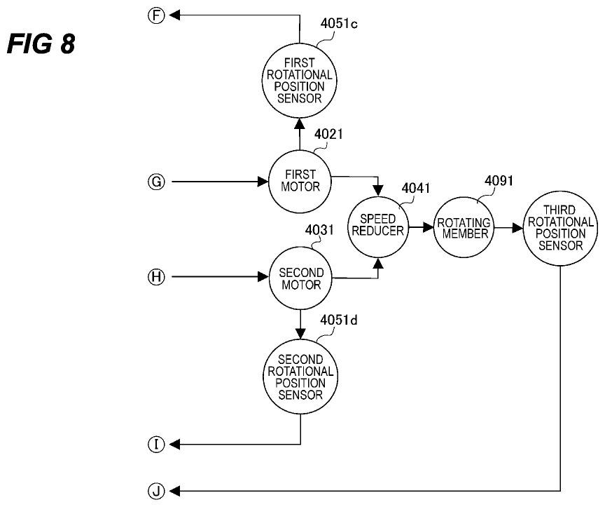

The motor control device 401 and the control target of the motor control device 401 have been described above. As illustrated in FIG. 3 and FIG. 4, it can be seen that the present embodiment has a configuration in which two motors are controlled by one current control circuit and one current detection circuit, unlike the conventional example illustrated in FIG. 7 and FIG. 8.

Next, an internal configuration of the motor control device 401 will be described.

The motor control device 401 includes a target speed generation circuit 4011, a speed control circuit 4012, a current control circuit 4013a, dq inverse conversion circuits 4014a and 4014b, PWM generation circuits 4015a and 4015b, electrical angle generation circuits 4016a and 4016b serving as first and second electrical angle instruction portions, a dq conversion circuit 4017a, and a speed detection circuit 4018.

When the control signal from the CPU 301a changes from 0 to 1 and the motor control device 401 starts operating, the target speed generation circuit 4011 determines and outputs a target speed signal based on a preset initial speed, target speed, and acceleration. When the control signal is switched to 0 again and the motor control device 401 stops operating, the target speed generation circuit 4011 decelerates the target speed signal based on the deceleration set in advance, and finally sets the target speed signal to 0.

The speed detection circuit 4018 detects a speed of the rotating member 409 from a pulse signal of the third rotational position sensor 4052. The cycle of the pulse signal is measured, and the speed is calculated from the cycle.

The speed control circuit 4012 that is a speed control portion outputs a d-axis current command and a q-axis current command. The d-axis current command is output as a fixed value of 0. A value of the q-axis current command is determined such that the target speed signal matches the detection speed of the rotating member 409. Specifically, the q-axis current command is determined by calculating a deviation that is a difference between the target speed and the detection speed and performing PI control on the deviation.

The dq conversion circuit 4017a calculates a d-axis detection current and a q-axis detection current from the detection current and the electrical angle, and outputs the d-axis detection current and the q-axis detection current.

The calculation formula is the following formula [Math. 1].

$$( \begin{matrix}{I}_{d} \\ {I}_{q}\end{matrix} ) = ( \begin{matrix}cos θ & sin θ \\ - sin θ & cos θ\end{matrix} ) ( \begin{matrix}1 & - \frac{1}{2} & - \frac{1}{2} \\ 0 & \frac{\sqrt{3}}{2} & - \frac{\sqrt{3}}{2}\end{matrix} ) ( \begin{matrix}{I}_{u} \\ {I}_{v} \\ {I}_{w}\end{matrix} ) \qquad [ Math . 1 ]$$

The current control circuit 4013a serving as a current control portion that controls driving currents of the first motor 402 and the second motor 403 determines a d-axis voltage command and a q-axis voltage command from the d-axis current command and the q-axis current command output from the speed control circuit 4012 and the d-axis detection current and the q-axis detection current output from the dq conversion circuit 4017a. The d-axis voltage command is determined by performing PI control on a deviation between the d-axis current command and the d-axis detection current. Similarly, the q-axis voltage command is determined by performing PI control on a deviation between the q-axis current command and the q-axis detection current.

The dq inverse conversion circuit 4014a calculates and outputs a U-phase voltage command, a V-phase voltage command, and a W-phase voltage command (three-phase voltage commands) from the d-axis voltage command, the q-axis voltage command, and the electrical angle of the first motor 402 generated by the electrical angle generation circuit 4016a.

Similarly, the dq inverse conversion circuit 4014b calculates and outputs three-phase voltage commands from the d-axis voltage command, the q-axis voltage command, and the electrical angle of the second motor 403 generated by the electrical angle generation circuit 4016b.

The calculation formula is the following formula [Math. 2].

$$( \begin{matrix}{V}_{u} \\ {V}_{v} \\ {V}_{w}\end{matrix} ) = ( \begin{matrix}1 & 0 \\ - \frac{1}{2} & \frac{\sqrt{3}}{2} \\ - \frac{1}{2} & - \frac{\sqrt{3}}{2}\end{matrix} ) ( \begin{matrix}cos θ & - sin θ \\ sin θ & cos θ\end{matrix} ) ( \begin{matrix}{V}_{d} \\ {V}_{q}\end{matrix} ) \qquad [ Math . 2 ]$$

In the present embodiment, the configuration of the speed control and the vector control is adopted, but the present disclosure is not limited to this control configuration in generating the driving voltage command. Other configurations may be adopted as long as a speed or a position of the rotating member 409 is controlled and the driving voltage command is generated using the electrical angle of the motor with the configurations.

The PWM generation circuit 4015a and the PWM generation circuit 4015b output PWM signals based on the voltage commands output from the dq inverse conversion circuits 4014a and 4014b, and provide the PWM signals to the driver 4061a and the driver 4061b, respectively.

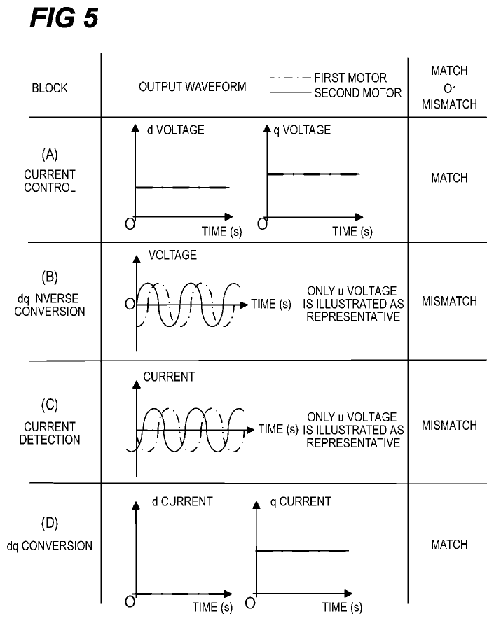

Here, the reason why only one current control circuit and one current detection circuit are required to generate the motor rotation voltage values to be supplied to the first motor 402 and the second motor 403 will be described with reference to a comparison diagram of output waveforms illustrated in FIG. 5, focusing on the output signals of the respective blocks by using the conventional example illustrated in FIG. 7 and FIG. 8.

In FIG. 7, six blocks according to the current control loop of the first motor 4021 are a current control circuit 4013c, a dq inverse conversion circuit 4014c, a PWM generation circuit 4015c, a driver 4061c, a current detection circuit 4071c, and a dq conversion circuit 4017c.

The six blocks related to the current control loop of the second motor 4031 are similar to the six blocks including the current control circuit 4013d, the dq inverse conversion circuit 4014d, the PWM generation circuit 4015d, the driver 4061d, the current detection circuit 4071d, and the dq conversion circuit 4017d.

The outputs of the current control circuits 4013c and 4013d are compared. The current control circuits 4013c and 4013d respectively receive dq current commands from the speed control circuit 40121. In addition, a dq detection current flowing in each motor is received from the dq conversion circuits 4017c and 4017d. Since the dq current commands that are inputs are the same and the dq detection currents are the same (the reason will be described in output comparison between dq conversion circuits 4017c and 4017d described later), the dq voltage commands that are outputs are the same between the first motor 4021 and the second motor 4031 as illustrated in FIG. 5(A).

The outputs of the dq inverse conversion circuits 4014c and 4014d are compared. Since the dq inverse conversion circuits 4014c and 4014d convert the same dq voltage commands into three-phase voltage commands at the electrical angle of each of the first motor 4021 and the second motor 4031 by using the above formula [Math. 2] and output the three-phase voltage commands, the phases of the three-phase voltage commands are different between the two motors as illustrated in FIG. 5(B).

The outputs of the dq conversion circuits 4017c and 4017d are compared. The dq conversion circuits 4017c and 4017d output dq detection currents. Although the three-phase currents that are the outputs of the current detection circuits 4071c and 4071d have different phases as illustrated in FIG. 5(C), the outputs of the dq detection currents of the two motors are the same between the first motor 4021 and the second motor 4031 as illustrated in FIG. 5(D) when calculation is performed by using the above formula [Math. 1] in combination with the respective electrical angles.

As described above, the output signals of the first motor 4021 and the second motor 403 are the same in the current control circuits 4013c and 4013d and the dq conversion circuits 4017c and 4017d. Therefore, the current control circuits 4013c and 4013d and the dq conversion circuits 4017c and 4017d can be shared by the first motor 4021 and the second motor 403. In addition, since the dq conversion circuits 4017c and 4017d are shared, only the current detection circuit 4071c can be shared out of the current detection circuits 4071c and 4071d, and the configuration in FIG. 3 and FIG. 4 is established.

The schematic internal configuration of the motor control device 401 has been described above.

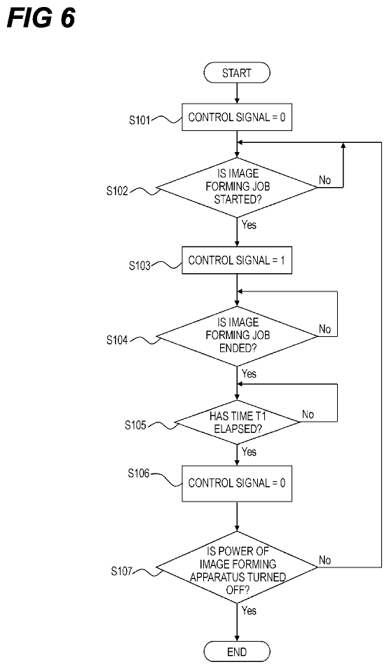

As described above, the motor control device 401 operates based on a control signal from the CPU 301a. Here, a control signal of the CPU 301a that drives the first motor 402 and the second motor 403 will be described with reference to FIG. 6. FIG. 6 is a flowchart illustrating an operation in which the CPU 301a outputs a control signal.

In FIG. 6, when the power of the image forming apparatus 100 is turned on, in step S101, the CPU 301a outputs the control signal=0. In this state, no voltage is applied to the first motor 402 and the second motor 403, and the first motor 402 and the second motor 403 are in a state of being uncontrolled.

When the image forming job is started in step S102, the process proceeds to step S103.

When the control signal becomes 1 in step S103, a voltage is applied to each of the first motor 402 and the second motor 403 based on the voltage command defined by the motor control device 401.

When a notification of the end of the image forming job is provided in step S104, the process proceeds to step S105, and after the time T1 elapses, the process proceeds to step S106. Here, the time T1 is a time until the motor decelerates from the target speed and stops.

In step S106, the control signal is set to 0, and the control of the motor is ended.

In step S107, when there is a command to turn off the power of the image forming apparatus 100, the power is turned off. When there is no command, the process returns to step S102 and waits for the next image forming job.

As described above, according to the configuration of the present embodiment, even if two motors are controlled by one common current control circuit and one common current detection circuit, it is possible to maintain driving performance equivalent to that of the configuration in which the current control circuit and the current detection circuit are provided for each of the two motors. As a result, when the two motors are controlled, only one current control circuit and one current detection circuit can be used in common, and the cost of the entire configuration can be reduced.

In the above embodiment, the configuration in which one load is driven and controlled by the two motors is described. However, the current control circuit and the current detection circuit can be similarly shared in a configuration in which the load is driven and controlled by a plurality of motors without being limited to the two motors.

According to the present disclosure, it is possible to provide a motor control device capable of obtaining, even if a current control circuit and a current detection circuit are not provided for each of a plurality of motors, motor driving performance equivalent to that of a configuration in which the circuits are provided for each of the plurality of motors in a configuration in which a load that is a driving target is driven by the plurality of motors, and achieving cost reduction, and an image forming apparatus equipped with the motor control device.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-071227, filed Apr. 23, 2025, which is hereby incorporated by reference herein in its entirety.

What is claimed is:

1. A motor control device comprising:
a first motor;
a second motor;
a driving force transmission unit that is connected to the first motor and the second motor and combines a driving force of the first motor and a driving force of the second motor and outputs a combined driving force;
a current control portion that controls driving currents of the first motor and the second motor in common;
a current detection unit that detects a driving current supplied to the first motor and feeds back the driving current to the current control portion;
a first rotational position detection unit that detects a rotational position of the first motor; and
a second rotational position detection unit that detects a rotational position of the second motor, wherein,
the current control portion:
controls a driving current of the first motor based on a driving current supplied to the first motor detected by the current detection unit and a rotational position of the first motor detected by the first rotational position detection unit, and
controls a driving current of the second motor based on the driving current supplied to the first motor detected by the current detection unit and a rotational position of the second motor detected by the second rotational position detection unit.

2. The motor control device according to claim 1, further comprising:
a first electrical angle instruction portion that gives an instruction for an electrical angle of the first motor to the current control portion based on the rotational position of the first motor detected by the first rotational position detection unit; and
a second electrical angle instruction portion that gives an instruction for an electrical angle of the second motor to the current control portion based on the rotational position of the second motor detected by the second rotational position detection unit.

3. The motor control device according to claim 1, wherein the driving force transmission unit is a speed reducer.

4. The motor control device according to claim 1, further comprising:
a first PWM generation unit that generates a PWM voltage for supplying the driving current controlled by the current control portion to the first motor; and
a second PWM generation unit that generates a PWM voltage for supplying the driving current controlled by the current control portion to the second motor.

5. The motor control device according to claim 4, further comprising:
a first driver that supplies the driving current to the first motor in response to the PWM voltage generated by the first PWM generation unit; and
a second driver that supplies the driving current to the second motor in response to the PWM voltage generated by the second PWM generation unit.

6. The motor control device according to claim 1, further comprising:
a driving target that is driven by the driving force that is output from the driving force transmission unit and is obtained by combining the driving force of the first motor and the driving force of the second motor;
a position information detection unit that detects operation position information of the driving target; and
a speed control unit that gives an instruction for the driving currents of the first motor and the second motor to the current control portion based on a target speed of the driving target and position information detected by the position information detection unit.

7. The motor control device according to claim 6, wherein the driving target is a rotating member.

8. The motor control device according to claim 7, wherein the driving target is a photosensitive drum or a fixing roller.

9. An image forming apparatus comprising:
the motor control device according to claim 1; and
an image forming portion that is controlled to form an image by the motor control device.
